(19) United States
(12) Patent Application Publication
(10) Pub. No.: US 2004/0025861 A1
(43) Pub. Date: Feb. 12, 2004

(54) Combination barbecue grill and cooker

(75) Inventors: Robert Johnston, Columbus, GA (US); James P. Jollay, Columbus, GA (US)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: W. C. BRADLEY COMPANY, Columbus, GA

(21) Appl. No.: 10/215,327

(22) Filed: Aug. 8, 2002

(51) Int. Cl. F24C 3/08; A47J 37/00

(52) U.S. Cl. 126/41 R; 126/276; 126/40; 126/50

(57) ABSTRACT

A gas grill assembly comprises a cooker adapted to operate on fuel supplied at a first fuel pressure. A grill is disposed substantially adjacent the cooker. The grill comprises a firebox and at least one burner disposed within the firebox. The burner is adapted to operate on fuel supplied at a second fuel pressure. A fuel supply is adapted to supply fuel to the cooker and to the burner. The fuel supply supplies fuel at a fuel supply pressure. The fuel supply pressure is converted to the first fuel pressure and the second fuel pressure for operation of the cooker and the grill.

### TECHNICAL FIELD

The present invention is generally related to heat generating devices and more particularly is related to a combination barbecue grill and cooker.

### BACKGROUND OF THE INVENTION

Various forms of cooking and heating food outdoors, such as grilling, boiling, deep frying, smoking, etc., are popular. Not only are all of these forms of cooking and heating popular, but the ability to implement them in various combinations to create one meal provides a user with great flexibility to create more diverse and interesting meals. For example, a surf and turf meal could be created by grilling steaks and boiling lobsters and corn in a pot.

Currently, the implementation of these multiple cooking methods for one meal requires the use of several distinct and separate apparatuses. For example, the surf and turf meal discussed above might require the use of an LP cooker, or the like, to boil the lobster and a barbecue grill for grilling the steak. LP cookers are typically fueled by a gas, such as propane, while the grill may be fueled by propane, or charcoal. Even where both the grill and the LP cooker are fueled by the same type of fuel, such as for example propane, separate fuel sources are typically used to accommodate the different fuel pressure supply requirements of an LP cooker and a gas grill.

Thus, a heretofore unaddresseed need exists in the industry to address the aforementioned deficiencies and inadequacies.

### SUMMARY OF THE INVENTION

Preferred embodiments of the present invention provide a combination barbecue grill and cooker Briefly described, in architecture, one embodiment of the apparatus can be implemented as follows. A gas grill assembly comprises a cooker adapted to operate on fuel supplied at a first fuel pressure. A grill is disposed substantially adjacent the cooker. The grill comprises a firebox and at least one burner disposed within the firebox. The burner is adapted to operate on fuel supplied at a second fuel pressure. A fuel supply is adapted to supply fuel to the cooker and to the burner. The fuel supply supplies fuel at a fuel supply pressure. The fuel supply pressure is converted to the first fuel pressure and the second fuel pressure for operation of the cooker and the grill.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a perspective view of an embodiment of a grill assembly of the present invention.

FIG. 2 is a back view of an embodiment of the gas grill assembly illustrated in FIG. 1.

FIG. 3 is a perspective view of an embodiment of a regulator of the gas grill assembly illustrated in FIG. 1.

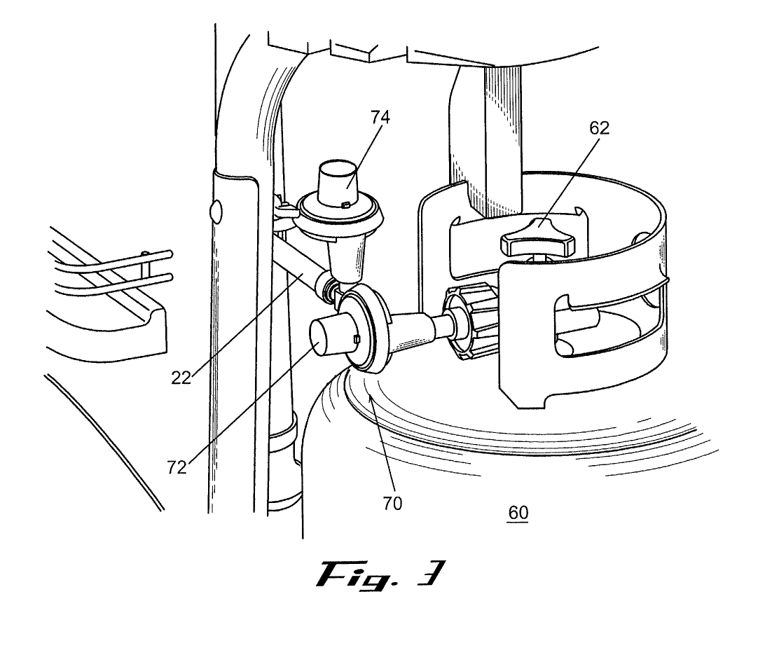

### DETAILED DESCRIPTION OF THE PREFERRED EMBODIMENTS

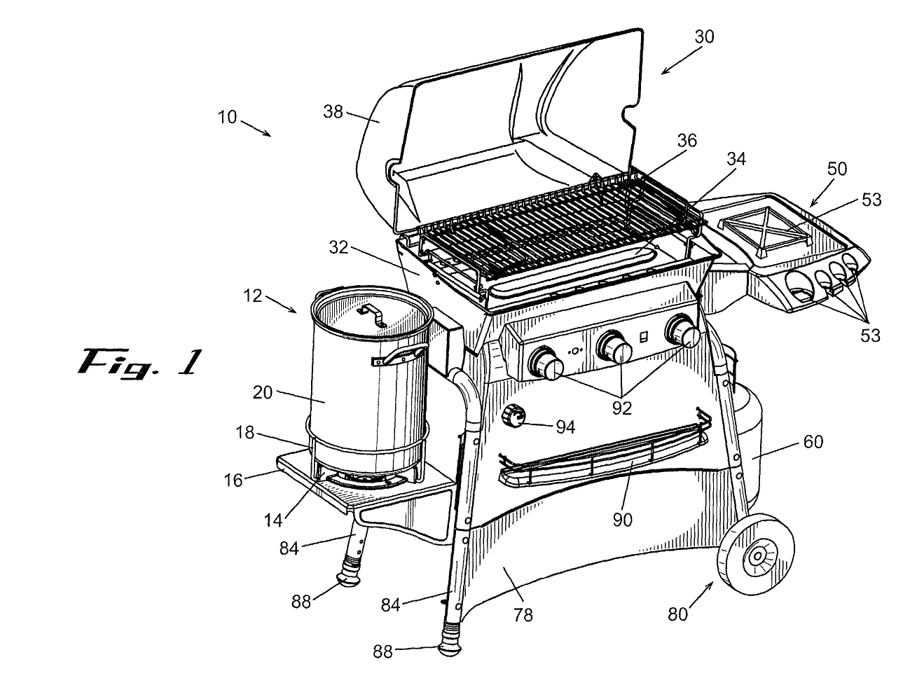

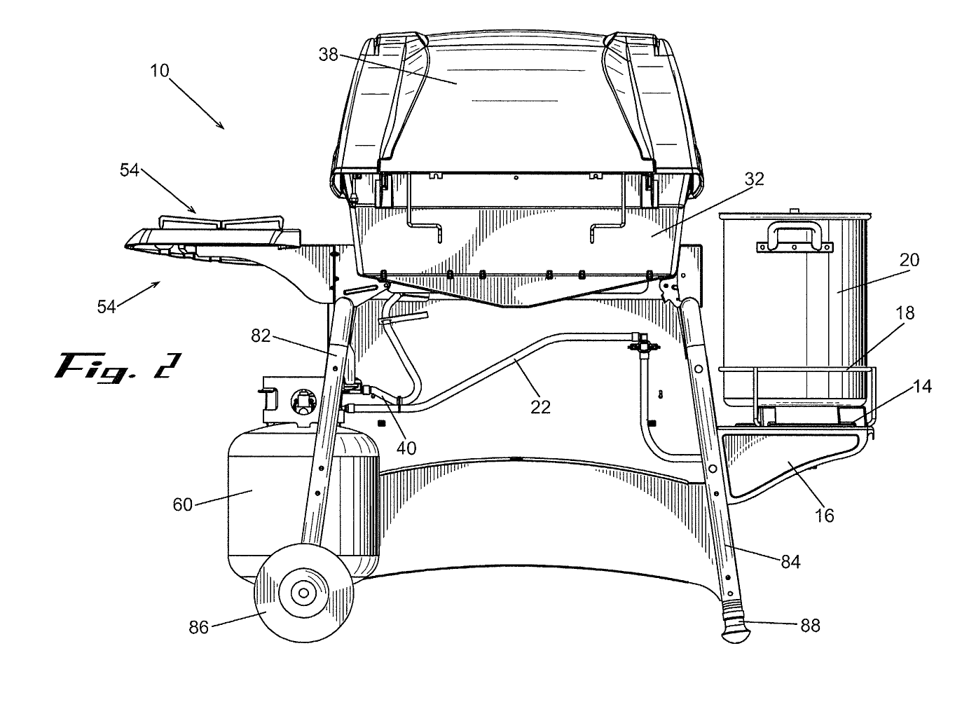

FIGS. 1 and 2 illustrate one preferred embodiment of a gas grill assembly 10 of the present invention. The gas grill assembly 10 comprises a cooker 12 and a gas grill 30 disposed substantially adjacent to each other. The cooker 12 preferably comprises a burner 14 disposed on a burner support 16. Although illustrated as suspended at a certain height, it should be understood that the burner support 16 can be either supported as illustrated or in any suitable manner, or can be adapted to sit on the ground or any surface. A pot support 18 is substantially concentrically aligned with the burner 14 and extends upwardly from the burner 14. The pot support 18 is illustrated as being substantially cage-like but can comprise any suitable configuration. A cooker fuel line 22 communicates fuel to the burner 14 from any suitable source of fuel. It is preferable that the cooker fuel line 22 supplies fuel to the burner 14 at a first fuel pressure being compatible with a fuel pressure preferred for operating the burner 14. Heat is produced at the burner 14 upon introducing fuel to the burner 14 and igniting the fuel expelled from the burner 14. A pot 20 can be placed on the burner 14 in order to heat or cook items placed therein. The pot support 18 aligns the pot 20, or any suitable cooking vessel, over the burner 14 and aids in preventing the pot 20 from falling off of or being knocked off of the burner 14. The cooker 12 can comprise an LP cooker, such as one known to one of ordinary skill in the art, and can be used to heat and cook various items. For example, water or broth can be placed in the pot 20 in which seafood, such as shrimp or lobsters, can be boiled or vegetables, such as corn or potatoes, can be cooked. Alternatively, oil can be placed in the pot 20 for frying food, such as, for example, a turkey.

The gas grill assembly 10 further comprises a gas grill 30. In one embodiment, the gas grill 30 comprises a firebox 32 in which at least one burner 34 is disposed. A cooking grate 36 is preferably removably disposed over the burner 34. A lid 38 is preferably hingedly fixed to the firebox 32. The lid can alternatively be fully removable from the firebox 32. Fuel is supplied to the burner 34 via grill fuel line 40. It is preferable that the grill fuel line 40 supplies fuel to the burner 34 at a second fuel pressure being compatible with fuel pressure preferred for operating the burner 34. Heat is produced at the burner 34 upon introduction of fuel to the burner 34 and igniting the fuel emitted from the burner 34. The fuel can be ignited by fire produced by a match, lighter, or the like. The fuel can also be ignited by a rotary igniter, such as those known to one of ordinary skill in the art. Various types of food can be placed on the cooking grate 36 and cooked or heated by the heat produced by the burner 34. The lid 38 can be closed over the cooking food or left in an open position (FIG. 1).

A fuel supply 60 provides fuel to both the cooker fuel line 22 and the grill fuel line 40. The fuel supply 60 outputs fuel at a fuel supply pressure. A regulator 70 converts the fuel supply pressure to the first fuel pressure, for the cooker supply line 22, and to the second fuel pressure, for the grill fuel line 40. More specifically, the regulator 70 comprises a first stage regulator 72 and a second stage regulator 74. The regulator 70 is disposed in communication with the fuel supply 60. A fuel supply valve 62 disposed on the fuel supply 60 is opened to begin the introduction of fuel (not shown) to the regulator 70. The fuel is first introduced to the first stage regulator 72 at a fuel supply pressure. The first stage regulator 72 converts the fuel from the fuel supply pressure to a first fuel pressure. The first stage regulator 72 feeds fuel to both the cooker fuel line 22, which supplies fuel to the cooker 12, and to the second stage regulator 74. The second stage regulator 74 converts fuel received at the first fuel supply pressure to a second fuel supply pressure. Fuel exits the second stage regulator 74 at a second fuel supply pressure and is delivered to the grill fuel line 40 (FIG. 2).

By way of example, the fuel supply 60 can comprise an LP fuel tank, which typically emits propane fuel at a pressure of approximately 120 psi to 150 psi. The cooker 12 can comprise an LP cooker that operates on a fuel pressure of approximately 10 psi. The grill 30 can comprise a barbecue gas grill that operates on a fuel pressure of approximately 0.5 psi. In this example, the first stage regulator 72 converts the approximately 120 psi to 150 psi fuel supply pressure to an approximately 10 psi first fuel pressure. That first fuel pressure is supplied both to the cooker supply line 22, in order to facilitate operation of the cooker 12 as desired, and to the second stage regulator 74. The second stage regulator 74 receives the first fuel pressure of approximately 10 psi and converts to the second fuel pressure of approximately 0.5 psi. Fuel at the second fuel pressure is output from the second stage regulator 74 to the grill fuel line 40 in order to facilitate operation of the grill 30 as desired. The above-referenced pressures and conversions are provided as an example only and are not intended to limit the present disclosure to such an application.

In one embodiment the cooker 12 and the gas grill 30 are disposed together on a grill cart 80. The grill cart 80 comprises four legs, referred to herein as a first leg pair 82 and a second leg pair 84. For mobility, each leg comprising the first leg pair 82 includes at least one wheel 86 in contact with the ground. Each leg comprising the second leg pair 84 each have at least one foot 88 in contact with the ground. The foot 88 can comprise a rubber or hard plastic cap, or the like. In order to move the cart, the grill cart 80 can be tilted such that each foot 88 is lifted from the ground and the grill cart 80 moved on the wheels 86. Alternatively, a wheel 86 can be disposed on each leg of the first leg pair 82 and the second leg pair 84.

The fuel supply 60 can optionally be included on the grill cart 80. In this configuration, the cooker fuel line 22 and the grill fuel line 40 are integrated with the grill cart 80 as well. The grill cart 80 further includes an optional front cover 78. The cooker fuel line 22 and the grill fuel line 40 are fixed to one side of the front cover 78, preferably underneath the firebox 32, or the back side of the front cover 78 (shown in FIG. 2). The front side of the front cover 78 (shown in FIG. 1) can optionally include a front shelf 90 disposed thereon.

The grill cart 80 optionally further includes a side shelf 50 (FIG. 1) in one configuration or, in another configuration, a side burner 54 (FIG. 2). The side shelf 50 extends from the grill cart 80 substantially adjacent the gas grill 30 and opposing the cooker 12. The side shelf 50 comprises a substantially flat planar surface 53 on which various items can be placed and supported. Optional accessory holders 52 can be included on the side shelf 50. Accessory holders 52 can be adapted to engage various grill cooking accessories such as a spatula, a fork, tongs, etc.

In another embodiment, a side burner 54 extends from the grill cart 80 substantially adjacent the gas grill 30 and opposing the cooker 12. The optional side burner 54 can comprise a grill side burner known to one of ordinary skill in the art. The side burner 54 can be adapted to receive fuel from the grill fuel line 40 or the cooker line 22.

The grill cart 80 preferably includes grill controls 92 and at least one cooker control 94 on the front side thereof (FIG. 1). Grill controls 92 comprise, for example, controls for igniting the burner 34, controlling the flame size at the burner 34, and turning the fuel supply to the burner 34 on and off. The cooker control 94 preferably controls the supply of and rate of supply of fuel to the burner 14 through the cooker fuel line 22.

It should be emphasized that the above-described embodiments of the present invention, particularly, an “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

Therefore, having thus described the invention, at least the following is claimed:

1. A gas grill assembly, comprising:
a cooker adapted to operate on fuel supplied at a first fuel pressure;
a grill disposed substantially adjacent said cooker, said grill having a firebox and at least one burner disposed within said firebox, said burner being adapted to operate on fuel supplied at a second fuel pressure; and
a fuel supply adapted to supply fuel to said cooker and to said burner; wherein said fuel supply supplies fuel at a fuel supply pressure;
wherein said fuel supply pressure is converted to said first fuel pressure and said second fuel pressure in order to operate said cooker and said grill.

2. The gas grill assembly of claim 1, further comprising:
a regulator being in communication with said fuel supply, said regulator being adapted to convert said fuel supply pressure to said first fuel pressure and said second fuel pressure.

3. The gas grill assembly of claim 2, wherein said regulator comprises:
a two-stage regulator having a first stage regulator adapted to convert said fuel supply pressure to said first fuel pressure and a second stage regulator adapted to convert said first pressure to said second fuel pressure.

4. The gas grill assembly of claim 1, further comprising:
a burner disposed substantially adjacent said grill, wherein said burner is adapted to operate on one of said first fuel pressure and said second fuel pressure.

5. The gas grill assembly of claim 1, wherein said cooker comprises an LP cooker.

6. The gas grill assembly of claim 1, wherein said fuel supply comprises an LP fuel tank.

7. The gas grill assembly of claim 1, further comprising:
a gas grill assembly cart adapted to support said grill and said cooker.

8. The gas grill assembly of claim 7, wherein said gas grill assembly cart further supports said fuel supply.

9. A gas cooking assembly, comprising:
a fuel source adapted to supply fuel at a fuel supply pressure;
a cooker adapted to operate on said fuel delivered at a first fuel pressure;
a food preparation apparatus adapted to operate on said fuel delivered at a second fuel pressure; and
a regulator adapted to convert said fuel supply pressure to at least a first fuel pressure and a second fuel pressure.

10. The gas cooking assembly of claim 9, further comprising:
a burner adapted to produce heat, said burner being adapted to operate on said fuel delivered at one of said first fuel pressure and said second fuel pressure.

11. The gas cooking assembly of claim 9, wherein said food preparation apparatus comprises a barbecue grill.

12. The gas cooking apparatus of claim 9, wherein said cooker comprises an LP cooker.

13. The gas cooking apparatus of claim 9, wherein said fuel source comprises an LP fuel tank.

14. The gas cooking apparatus of claim 9, further comprising:
a grill cart assembly supporting said fuel source, said cooker, said food preparation apparatus and said regulator thereon.

15. The gas cooking apparatus of claim 9 wherein said grill cart assembly comprises wheels.

16. A gas grill assembly, comprising:
a first heat generating means for producing heat, said first heat generating means being adapted to operate on fuel supplied at a first fuel pressure;
a second heat generating means for producing heat, said second heat generating means being adapted to operate on said fuel supplied at a second fuel pressure;
a fuel supply means for supplying fuel, said fuel supply means adapted to supply fuel at a fuel supply pressure;
a regulating means for converting said fuel supply pressure to said first fuel pressure and said second fuel pressure.

17. The gas grill assembly of claim 16, further comprising:
a third heat generating means for producing heat, said third heat generating means being adapted to operate on one of said first fuel pressure and said second fuel pressure.

18. A fuel operated appliance assembly, comprising:
a multi-stage fuel regulator, wherein said multi-stage fuel regulator is adapted to communicate fuel to said fuel operated appliance assembly at a first fuel pressure and at a second fuel pressure.

19. The fuel operated appliance assembly of claim 18, wherein said multi-stage fuel regulator comprises:
a two-stage fuel regulator, said two-stage fuel regulator comprising a first stage regulator adapted to communicate fuel to said fuel operated apparatus at said first fuel pressure and a second stage regulator adapted to communicate fuel to said fuel operated apparatus at said second fuel pressure.

20. The fuel operated appliance assembly of claim 18, further comprising:
a first fuel operated appliance adapted to operate on fuel at a first fuel pressure;
a second fuel operated appliance adapted to operate on fuel at a second fuel pressure; and
a fuel supply being in fluid communication with said multi-stage fuel regulator;
wherein said multi-stage fuel regulator is in fluid communication with said first fuel operated appliance and said second fuel operated appliance.
